(19) United States
(12) Patent Application Publication
(10) Pub. No.: US 2016/0094316 A1
(43) Pub. Date: Mar. 31, 2016

(54) HARQ ID CHOICE FOR LTE TRAFFIC IN TX SHARING SYSTEMS

(71) Applicant: QUALCOMM Incorporated, San Diego, CA (US)

(72) Inventors: Anthony Alfy Fanous, San Diego, CA (US); Deepak Krishnamoorthi, San Diego, CA (US); Jong Hyeon Park, San Jose, CA (US)

(73) Assignee: QUALCOMM Incorporated, San Diego, CA (US)

(21) Appl. No.: 14/500,773

(22) Filed: Sep. 29, 2014

(51) Int. Cl. H04L 1/18; H04W 72/12

(52) U.S. Cl. CPC H04L 1/1887; H04W 72/1263; H04L 1/1812

(57) ABSTRACT

Systems and methods are described for scheduling transmission for a first radio access technology (RAT) and a second RAT including, but not limited to, determining likelihood of successful transmission for each of a plurality of frames associated with the second RAT based on an activity pattern associated with the first RAT. Transmission cost associated with each of a plurality of data blocks is determined. Each of the plurality of data blocks is transmittable via the second RAT. A first data block of the plurality of data blocks is assigned to a frame of the plurality of frames based, at least in part, on the likelihood of successful transmission associated with the frame and the transmission cost associated with the first data block (the data with highest priority/delay sensitivity is assigned to the subframe with highest likelihood of success).

### BACKGROUND

1. Field

Embodiments described herein generally relate to scheduling data traffic of a radio access technology, and specifically, to scheduling data traffic of the radio access technology based on a blanking pattern associated with another radio access technology activity.

2. Background

A user equipment (“UE”), such as a mobile phone device, may be enabled for one or more radio access technologies (“RATs”), such as Frequency Division Multiple Access (FDMA), Time Division Multiple Access (TDMA), Code Division Multiple Access (CDMA), Universal Mobile Telecommunications Systems (UMTS) (particularly, Long Term Evolution (LTE)), Global System for Mobile Communications (GSM), Wi-Fi, PCS, or other protocols that may be used in a wireless communications network or a data communications network. One or more RATs may be enabled by one or a plurality of subscriber identity modules (“SIMs”). For example, a UE may be a multi-SIM UE, where each of a plurality of SIMs received or otherwise coupled to the multi-SIM UE may support one or more RATs.

Two or more radio access technologies (RATs) may share a same set of transmission hardware of the UE. When one RAT is assigned the set of transmission hardware, transmission for other RAT(s) may be halted, given that the transmission hardware may support only one RAT at a time. For example, a given UE may be operable in both Global System for Mobile Communication (GSM) and Long Term Evolution (LTE). Transmission hardware of the UE may not support LTE transmissions while GSM is active. Intelligent transmission scheduling of data for both RATs may improve data throughput of the UE, in which two or more RATs share the transmission hardware but one may transmit at any given time.

### SUMMARY

Various embodiments relate to systems and processes for scheduling transmission for a first radio access technology (RAT) and a second RAT, for example, the process including, but not limited to, determining likelihood of successful transmission for each of a plurality of frames associated with the second RAT based on an activity pattern associated with the first RAT; determining transmission cost associated with each of a plurality of data blocks transmittable via the second RAT; and assigning a first data block of the plurality of data blocks to a frame of the plurality of frames based, at least in part, on the likelihood of successful transmission associated with the frame and the transmission cost associated with the first data block.

In some embodiments, the first RAT is Global System for Mobile Communication (GSM); and the second RAT is Long Term Evolution (LTE).

In some embodiments, the first RAT is associated with voice transmission; and the second RAT is associated with data transmission.

In various embodiments, the first RAT is a different RAT from the second RAT.

In some embodiments, the process further includes receiving the activity pattern associated with the first RAT; and determining the blanking pattern associated with the second RAT based on the activity pattern received, wherein at least one symbol of one of the plurality of frames is blanked due to the activity pattern.

In various embodiments, the determining of the likelihood of successful transmission comprises determining, for each of the plurality of frames, a number of symbols blanked due to the activity pattern associated with the first RAT; and the likelihood of successful transmission decreases as the number of symbols blanked increases.

In some embodiments, the determining of the likelihood of successful transmission is determined for each of the plurality of frames based on at least one of the following attributes associated with each of the plurality of frames: data symbols blanked, reference symbols blanked, and frame delay.

According to some embodiments, the determining of the likelihood of successful transmission is determined based on a weighted combination of the data symbols blanked, the reference symbols blanked, and the frame delay.

In some embodiments, the determining of the transmission cost associated with each of the plurality of data blocks is determined based on at least one of: priority associated with each of the plurality of data blocks and delay sensitivity associated with each of the plurality of data In some embodiments, the priority associated with each of the plurality of data blocks is determined based on classification associated with each of the plurality of data blocks.

In some embodiments, the priority associated with each of the plurality of data blocks is determined based on classification associated with each of the plurality of data blocks.

In various embodiments, the classification corresponds to a media access control (MAC) layer, such that signaling radio bearer (SRB) data, transmission control protocol acknowledgment (TCP ACK) data, radio link control acknowledgement (RLC ACK) data blocks are associated with a high priority level, and that user application data blocks are associated with a low priority.

In some embodiments, the delay sensitivity associated with each of the plurality of data blocks is determined based on classification associated with each of the plurality of data blocks.

In various embodiments, the determining of the transmission cost is a weighted combination of the priority and the delay sensitivity.

According to some embodiments, the transmission cost decreases as the priority increases.

In some embodiments, the transmission cost decreases as the delay sensitivity increases.

In some embodiments, the process further includes assigning a second data block of the plurality of data blocks to another frame of the plurality of frames, wherein the first data block is associated with a lower transmission cost than the second data block, and the frame is associated with a higher likelihood of successful transmission than the another frame.

According to various embodiments, a system for scheduling transmission for a first radio access technology (RAT) and a second RAT, the system including, but not limited to a scheduling module, the scheduling module configured to: determine likelihood of successful transmission for each of a plurality of frames associated with the second RAT based on an activity pattern associated with the first RAT; determine transmission cost associated with each of a plurality of data blocks transmittable via the second RAT; and assign a first data block of the plurality of data blocks to a frame of the plurality of frames based, at least in part, on the likelihood of successful transmission associated with the frame and the transmission cost associated with the first data block.

In some embodiments, the first RAT is Global System for Mobile Communication (GSM); and the second RAT is Long Term Evolution (LTE).

In some embodiments, the first RAT is associated with voice transmission; and the second RAT is associated with data transmission.

In some embodiments, the first RAT is a different RAT from the second RAT.

In various embodiments, the scheduling module is further configured to: receive the activity pattern associated with the first RAT; and determine the blanking pattern associated with the second RAT based on the activity pattern received. At least one symbol of one of the plurality of frames is blanked due to the activity pattern.

In some embodiments, the scheduling module determines the likelihood of successful transmission by determining, for each of the plurality of frames, a number of symbols blanked due to the activity pattern; and the likelihood of successful transmission decreases as the number of symbols blanked increases.

In various embodiments, the likelihood of successful transmission is determined by the scheduling module for each of the plurality of frames based on at least one of the following attributes associated with each of the plurality of frames: data symbols blanked, reference symbols blanked, and frame delay.

According to various embodiments, the transmission cost associated with each of the plurality of data blocks is determined by the scheduling module based on at least one of: priority associated with each of the plurality of data blocks and delay sensitivity associated with each of the plurality of data blocks.

In some embodiments, the transmission cost is a weighted combination of the priority and the delay sensitivity.

In some embodiments, the transmission cost decreases as the priority increases.

In various embodiments, the transmission cost decreases as the delay sensitivity increases.

In some embodiments, scheduling module is further configured to assign a second data block of the plurality of data blocks to another frame of the plurality of frames, wherein the first data block is associated with a lower transmission cost than the second data block, and the frame is associated with a higher likelihood of successful transmission than the another frame.

In various embodiments, a non-transitory computer readable-medium containing instructions such that, when executed, causes a processor to: determine likelihood of successful transmission for each of a plurality of frames associated with the second RAT based on an activity pattern associated with the first RAT; determine transmission cost associated with each of a plurality of data blocks transmittable via the second RAT; and assign a first data block of the plurality of data blocks to a frame of the plurality of frames based, at least in part, on the likelihood of successful transmission associated with the frame and the transmission cost associated with the first data block.

In some embodiments, a system for scheduling transmission for a first radio access technology (RAT) and a second RAT, the system including, but not limited to: means for determining likelihood of successful transmission for each of a plurality of frames associated with the second RAT based on an activity pattern associated with the first RAT; means for determining transmission cost associated with each of a plurality of data blocks transmittable via the second RAT; and means for assigning a first data block of the plurality of data blocks to a frame of the plurality of frames based, at least in part, on the likelihood of successful transmission associated with the frame and the transmission cost associated with the first data block.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the various embodiments.

FIG. 1 is a schematic diagram of a system in accordance with various embodiments.

FIG. 2 is a process flowchart diagram illustrating a traffic scheduling process according to various embodiments.

FIG. 3 is a process flowchart diagram illustrating a process for determining a likelihood of successful transmission for one of frames associated with a second RAT according to various embodiments.

FIG. 4 is a block diagram illustrating an example of activity patterns associated with a first RAT and corresponding blanking patterns associated with a second RAT according to various embodiments.

FIG. 5 is a process flowchart diagram illustrating an example of a likelihood determination process for determining a likelihood of successful transmission for a frame index value according to various embodiments.

FIG. 6 is an example of a weighting factor mapping table illustrating an example of a relationship between at least one weight factor and a corresponding number of symbols blanked according to various embodiments.

FIG. 7 is an example of relationship table illustrating the relationship between MCS and the number of ordinary symbols blanked while ensuring correct decoding at the eNodeB according to various embodiments.

FIG. 8 is a HARQ ID cost table illustrating examples of the index cost associated with each HARQ ID according to some embodiments.

FIG. 9 is a process flowchart diagram illustrating a transmission cost determination process for determining a transmission cost associated with a data block according to various embodiments.

FIG. 10 is a transmission cost table according to various embodiments.

FIG. 11 is a component block diagram of a user equipment suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the invention or the claim.

Some modern communication devices, referred to herein as user equipment (UE) or mobile station (MS), may include devices such as smart phones, tablet computers, and laptop computers. A UE may include one or more subscriber identity modules (SIMs) that provide users of the UEs with access to one or multiple separate mobile networks, supported by radio access technologies (RATs). Examples of UEs include, but are not limited to, mobile phones, laptop computers, smart phones, and other mobile communication devices of the like that are configured to connect to one or more RATs. Examples of RATs include, but are not limited to, Frequency Division Multiple Access (FDMA), Time Division Multiple Access (TDMA), Code Division Multiple Access (CDMA), Universal Mobile Telecommunications Systems (UMTS) (particularly, Long Term Evolution (LTE)), Global System for Mobile Communications (GSM), Wi-Fi, PCS, or other protocols that may be used in a wireless communications network or a data communications network.

Embodiments described herein related to both single-SIM and multi-SIM UEs. A UE that includes a plurality of SIMs and connects to two or more separate RATs using a same set of transmission hardware (e.g., radio-frequency (RF) transceivers) is a multi-SIM-multi-standby (MSMS) communication device. In one example, the MSMS communication device may be a dual-SIM-dual-standby (DSDS) communication device, which may include two SIM cards/subscriptions that may both be active on standby, but one is deactivated when the other one is in use. In another example, the MSMS communication device may be a triple-SIM-triple-standby (TSTS) communication device, which includes three SIM cards/subscriptions that may all be active on standby, where two may be deactivated when the third one is in use. In other examples, the MSMS communication device may be other suitable multi-SIM communication devices, with, for example, four or more SIMs, such that when one is in use, the others may be deactivated.

Further, a UE that includes a plurality of SIMs and connects to two or more separate mobile networks using two or more separate sets of transmission hardware is termed a multi-SIM-multi-active (MSMA) communication device. An example MSMA communication device is a dual-SIM-dual-active (DSDA) communication device, which includes two SIM cards/subscriptions, each associated with a separate RAT. Both SIMs may remain active at any given time. In another example, the MSMA device may be a triple-SIM-triple-active (TSTA) communication device, which includes three SIM cards/subscriptions, each associated with a separate RAT. All three SIMs may remain active at any given time. In other examples, the MSMA communication device may be other suitable multi-SIM communication devices with four or more SIMs, for which that all SIMs may be active at any given time.

Referring to embodiments in which the UE may include one set of transmission hardware (e.g., in MSMS cases), usage of the transmission hardware by the RATs may be scheduled to ensure that no overlapping usage occurs. This is because the one set of transmission hardware (e.g., RF resources, Tx, and the like) may only support communication (including, but not limited to, the uplink direction) for one RAT at a given time. According, intelligent scheduling of usage of the available set of transmission hardware as described herein can advance efficient utilization of the transmission hardware, and thus improving communication throughput.

Embodiments are also directed to UEs having two or more sets of transmission hardware (e.g., in MSMA cases). Despite that two or more RATs may be both active simultaneously due to having two or more sets of available transmission hardware, each of the two or more RATs may interfere with communication of other RATs (e.g., over desense bands). To overcome the interference, symbols or frames for one RAT may be blanked (i.e., ignored or not transmitted) when another RAT is active. Thus, similar to the cases involve a single set of transmission hardware, UEs having two or more sets of transmission hardware can similarly benefit from embodiments described herein related to efficient scheduling of data traffic involving two or more RATs.

As used herein, “frame” refers to any suitable definable boundaries of the RATs involved, including, but not limited to, frames, subframes, slots, and/or the like. A “second data block” may refer to a data segment or unit transmittable via the second RAT.

As used herein, a UE refers to one of a cellular telephone, smart phone, personal or mobile multi-media player, personal data assistant, laptop computer, personal computers, tablet computer, smart book, palm-top computer, wireless electronic mail receiver, multimedia Internet-enabled cellular telephone, wireless gaming controller, and similar personal electronic device that include one or more SIMs, a programmable processor, memory, and circuitry for connecting to one or more mobile communication networks (simultaneously or sequentially).

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the term “SIM” may also be used herein as a shorthand reference to the communication service associated with and enabled by the information (e.g., in the form of various parameters) stored in a particular SIM as the SIM and the communication network, as well as the services and subscriptions supported by that network, correlate to one another.

Embodiments described herein are related to improving data traffic for two or more RATs associated with a UE by efficiently scheduling data communication for the two or more RATs. While embodiments are described with respect to two RATs, one of ordinary skill in the art could appreciate that the embodiments may also be implemented for three or more RATs. Particular embodiments related to GSM (as a first RAT) and LTE (as a second RAT) are set forth for demonstrative purposes and should not be construed as limiting. Embodiments may be implemented for other types of RATs in the same or similar manner consistent with the spirit of the description.

Typically, a first RAT (e.g., GSM) may be assigned the transmission hardware. When the first RAT is active, the UE may communicate via the first RAT at certain symbols while rest at other symbols. An activity (e.g., blanking) pattern of the first RAT may refer to the transmitting/receiving-and-resting patterns when the first RAT is active. During the activities of the first RAT, a second RAT (e.g., LTE) may be scheduled to utilize the transmission hardware based on the activity pattern of the first RAT. Specifically, the second RAT may be scheduled to utilize the transmission hardware when the first RAT is resting. Specific embodiments may relate to LTE associating with hybrid automatic repeat request (HARQ) processes.

Embodiments efficiently schedule activities of the second RAT to maximize the amount of successful data transmission via the second RAT. An individual data block may be transmittable via a frame (or a subframe as in the cases of the LTE implementing the HARQ processes) of the second RAT. In general, data traffic for the second RAT is scheduled based on viability of particular frames and/or transmission cost associated the data block. The viability of each frame may refer to the likelihood of successful transmission determined based on the activity pattern of the first RAT. For example, a likelihood of successful transmission may be high when the frame of the second RAT does not overlap or coincide with activities of the first RAT. On the other hand, the likelihood of successful transmission may be low when more than half of symbols associated with the frame are forced to be blanked due to activities of the first RAT. The transmission cost may be computed based on priority level associated with each of the data block. The transmission cost may also be computed based on delay sensitivity (or delay tolerance) associated with each of the data block. Data blocks associated with low transmission cost (higher priority and higher delay sensitivity) may be matched with frames with high likelihood of successful transmission and transmitted accordingly.

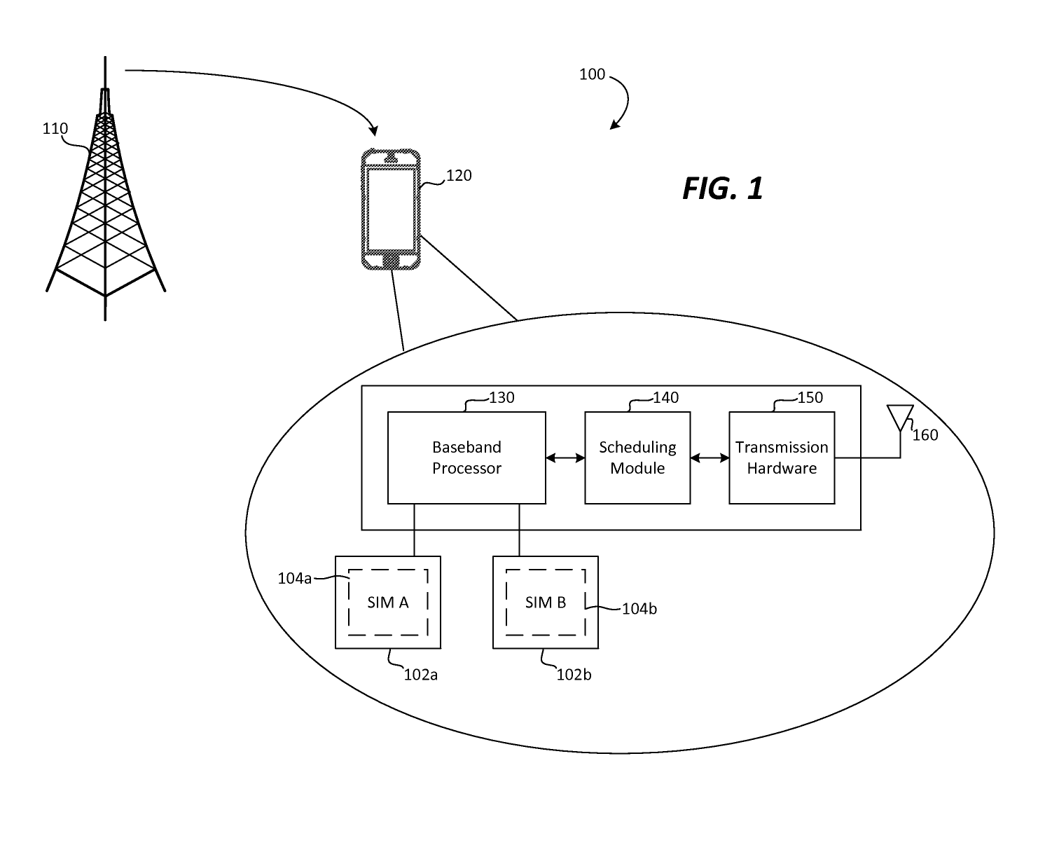

With reference to FIG. 1, a schematic diagram of a system 100 is shown in accordance with various embodiments. The system 100 may include a base station 110 and a UE 120. In some embodiments, the base station 110 and the UE 120 may be in communication via one or more networks enabled by the RATs, such as, but not limited to, FDMA, TDMA, CDMA, UMTS (particularly, LTE), GSM, Wi-Fi, PCS, or other protocols that may be used in a wireless communications network or a data communications network. The base station 110 may enable the one or more RATs. By way of illustrating with a non-limiting example, the base station 110 may enable communication with the UE 120 via GSM (e.g., for voice signals) and LTE (e.g., for data signals). Alternatively, the base station 110 may include two or more base stations, where a first base station may enable communication via a first RAT, and a second base station may enable communication via a second RAT.

The base station 110 may each include at least one antenna group or transmission station located in the same or different areas, where the at least one antenna group or transmission station may be associated with signal transmission and reception. The base station 110 may each include one or more processors, modulators, multiplexers, demodulators, demultiplexers, antennas, and the like for performing the functions described herein. In some embodiments, the base station 110 may be an access point, Node B, evolved Node B (eNode B or eNB), base transceiver station (BTS), or the like.

In various embodiments, the UE 120 may be in communication with the base station 110 via the RATs (e.g., receive/transmit signals of the first and the second RAT from/to the base station 110). The UE 120 may be configured to access the RATs by virtue of the multi-SIM and/or the multi-mode SIM configuration of the UE 120. When a SIM corresponding to a RAT is received, the UE 120 may access that RAT based on the information stored on the SIM(s).

According to various embodiments, the UE 120 may include at least a baseband processor 130, scheduling module 140, and, transmission (Tx) hardware 150. The transmission hardware 150 may be coupled to a wireless antenna 160 to enable wireless data transmission and reception with the base station 110. The baseband processor 130 may be coupled to at least one SIM interface to enable a plurality of RATs for the UE 120. The baseband processor 130 may be connected to a first SIM interface 102a and a second SIM interface 102b. Each of the SIM interfaces 102a, 102b may be configured to receive a SIM (e.g., SIM A 102a, SIM B 102b, respectively).

The transmission hardware 150 (e.g., RF resources) may include transceivers that perform transmission functions for the associated SIM(s) of the UE 120. The transmission hardware 150 may include transmit circuitry. In some embodiments, the transmission hardware 150 may also include a receiving circuitry (Rx). Alternatively, the transmission hardware 150 may include a transceiver that combines the transmitter and receiver. In some embodiments, the transmission hardware 150 is a set of transmission hardware that may enable communication via two or more RATs. In further embodiments, the UE 120 may include two or more sets of transmission hardware 150.

The UE 120 is configured to receive one or more SIMs (e.g., SIM A 104a and SIM B 104b). Each of the SIMs 104a, 104b may be a Universal Integrated Circuit Card (UICC) that is configured with SIM and/or USIM applications, enabling access to various RAT networks. The UICC may also provide storage for a phone book and other applications. Alternatively, in a CDMA network, a SIM may be a UICC removable user identity module (R-UIM) or a CDMA subscriber identity module (CSIM) on a card. A SIM may include a CPU, ROM, RAM, EEPROM and I/O circuits. An Integrated Circuit Card Identity (ICCID) SIM serial number may be printed on the SIM card for identification. However, a SIM may be implemented within a portion of memory of the UE 120, and thus need not be a separate or removable circuit, chip or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The baseband processor 130 may perform baseband/modem functions for communications on at least one SIM and may include one or more amplifiers and radios. In embodiments where two or more sets of transmission hardware (each may be the transmission hardware 150) are provided, the two or more sets of transmission hardware may share the baseband processor 130. In other words, the baseband processor 130 may be a single device that performs baseband/modem functions for all SIMs on the UE 120). In other embodiments, each transmission hardware 150 may include physically or logically separate baseband processor such as the baseband processor 130.

In some embodiments, the scheduling module 140 may be coupled to the baseband processor 130 and the transmission hardware 150. In other embodiments, the scheduling module 140 may be a part of the baseband processor 130 or is a layer implemented with the baseband processor 130. The scheduling module 140 may perform functions described herein related to the scheduling of traffic data for the first RAT and the second RAT. In other embodiments, the scheduling module 140 may be a standalone component within the UE 120 having its own hardware (e.g., a processor, memory, and/or the like). In particular embodiments, the scheduling module 140 may include or may be a part of a general RAT-scheduling layer (e.g., for the second RAT). The scheduling module 140 may include or may be a part of a ML1 layer for scheduling a second RAT (e.g., LTE) data traffic.

The UE 120 may further include at least one general purpose processor (not shown) and at least one memory (not shown). One or more of the baseband processor 130, the scheduling module 140, and the transmission hardware 150 may include the general purpose processor and/or the memory. Alternatively, at least one of the baseband processor 130, the scheduling module 140, and the transmission hardware 150 may be externally coupled to the general purpose processor and/or the memory.

The processor may include any suitable data processing device, such as a general-purpose processor (e.g., a microprocessor), but in the alternative, the processor may be any suitable electronic processor, controller, microcontroller, or state machine. The processor may also be implemented as a combination of computing devices (e.g., a combination of a DSP and a microprocessor, a plurality of microprocessors, at least one microprocessors in conjunction with a DSP core, or any other such configuration).

The memory may be operatively coupled to the processor and may include any suitable internal or external device for storing software and data for controlling and use by the processor to perform operations and functions described herein, including, but not limited to, random access memory RAM, read only memory ROM, floppy disks, hard disks, dongles or other recomp sensor board (RSB) connected memory devices, or the like. The memory may store an operating system (“OS”), as well as user application software and executable instructions. The memory may also store application data, such as an array data structure.

In some embodiments, the baseband processor 130, the scheduling module 140, and the transmission hardware 150 (and associated processor/memory) may be included in the UE 120 as a system-on-chip. In some embodiments, the one or more SIMs (e.g., the SIM A 104a and the SIM B 104b) as well as their corresponding interfaces (e.g., the first interface 102a and the second interface 102b, respectively) may be external to the system-on-chip. Further, various input and output devices may be coupled to components on the system-on-chip, such as interfaces or controllers.

In embodiments in which the UE 120 comprises a smart phone or other mobile phone device, the UE 120 may have existing hardware and software for telephone and other typical wireless telephone operations, as well as additional hardware and software for providing functions as described herein. Such existing hardware and software includes, for example, one or more input devices (such as, but not limited to keyboards, buttons, touchscreens, cameras, microphones, environmental parameter or condition sensors), display devices (such as, but not limited to electronic display screens, lamps or other light emitting devices, speakers or other audio output devices), telephone and other network communication electronics and software, processing electronics, electronic storage devices and one or more antennae and receiving electronics for receiving various RATs. In such embodiments, some of that existing electronics hardware and software may also be used in the systems and processes for functions as described herein.

Accordingly, such embodiments can be implemented with minimal additional hardware costs. However, other embodiments relate to systems and process that are implemented with dedicated device hardware specifically configured for performing operations described herein. Hardware and/or software for the functions may be incorporated in the UE 120 during manufacturing, for example, as part of the original equipment manufacturer's (“OEM's”) configuration of the UE 120. In further embodiments, such hardware and/or software may be added to the UE 120 post-manufacture, such as by installing one or more software applications onto the UE 120.

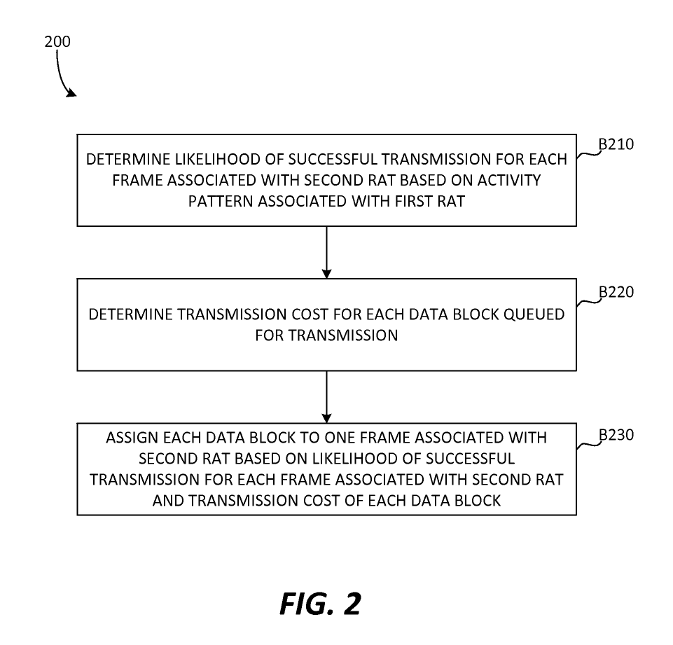

FIG. 2 is a process flowchart diagram illustrating a traffic scheduling process 200 according to various embodiments. Now referring to FIGS. 1-2, the traffic scheduling process 200 may be implemented on the UE 120 (e.g., by a general purpose processor, baseband processor 130, scheduling module 140, and/or the like). First at block B210, the scheduling module 140 of the UE 120 may determine likelihood of successful transmission for each frame of the second RAT associated with the second RAT based on activity pattern associated with the first RAT. As used herein, the frames of the second RAT refer generally to frames or subframes for transmitting data blocks via the second RAT.

In some embodiments, the scheduling module 140 may schedule a predetermined number of frames of the second RAT before these frames of the second RAT are executed. The scheduling module 140 may schedule the frames of the second RAT for a predetermined time period in which the first RAT is assigned the transmission hardware 150 for communication activities. During the assignment, the first RAT may exhibit an activity pattern as described. Based on such activity pattern, the scheduling module 140 may determine a blanking pattern of the second RAT (i.e., symbols of the second RAT may be blanked when the first RAT is active). The likelihood of successful transmission may in turn be determined based on the number of symbols blanked for each frame of the second RAT. Delay of each frame of the second RAT may also be factored into computing the favorability of transmitting over a particular second Rat's frame (frame of the second RAT).

Next at block B220, the scheduling module 140 may determine transmission cost for each data block queued for transmission. In typical embodiments, a data block may be transmittable via each frame of the second RAT associated with the second RAT. The transmission cost may be determined based on the content of the data blocks in the manner described. For example, the transmission cost may be determined based on the priority and/or delay sensitivity associated with each data block. The blocks B210 and B220 may be executed sequentially in any order or simultaneously.

Next at block B230, the scheduling module 140 may assign each data block to one of the frames of the second RAT based on the likelihood of successful transmission for each of the frames of the second RAT and the transmission cost for each data block. In some embodiments, the scheduling module 140 may assign each data block to one of the frames of the second RAT, which may be identified by a unique frame index identifier.

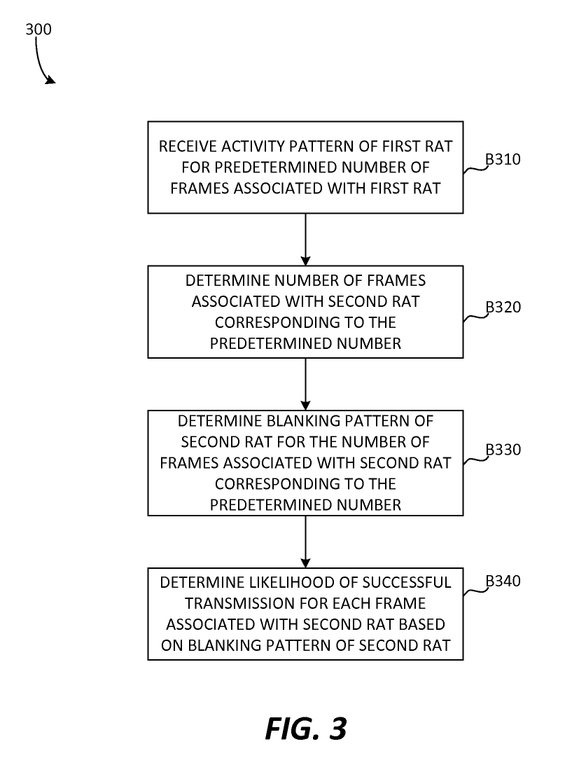

FIG. 3 is a process flowchart diagram illustrating a process 300 for determining a likelihood of successful transmission for one of the frames of the second RAT according to various embodiments. Now referring to FIGS. 1-3, the process 300 may be implemented on the UE 120 (e.g., by the general purpose processor, baseband processor 130, scheduling module 140, and/or the like). The process 300 may include some particular implementations of the block B210.

First at block B310, the scheduling module 140 may receive activity pattern of the first RAT for a predetermined number of frames of the first RAT. The frames of the first RAT may be transmission frames configured for transmitting data via the first RAT. Transmission activities for the first RAT may be determined in advance. That is, the data blocks may be assigned to at least one frame of the first RAT associated with the first RAT before those assigned frames of the first RAT are actually transmitted. Accordingly, when the first RAT is assigned (e.g., by a scheduling component for the first RAT) to use the transmission hardware 150, activities (data block transmission) and inactivity (rest) may be determined in advance for a predetermined number of frames. Such activities and inactivity may constitute the activity pattern of the first RAT. The activity pattern of the first RAT may be determinable by any suitable scheduling component associated with the first RAT. In particular examples, a coexistence manager (C×M) module layer and/or the baseband processor 130 associated with the first RAT may determine and store the activity pattern of the first RAT. The scheduling module 140 may receive the activity pattern of the first RAT from the scheduling component associated with the first RAT.

Next at block B320, the scheduling module 140 may determine a number of frames of the second RAT corresponding to the predetermined number of the frames of the first RAT. As the first RAT and the second RAT are separate technologies, the sizes of each of the frames of the first RAT and the sizes of each of the frames of the second RAT may vary. The first RAT is capable of being scheduled for a predetermined period of time (as divided into the predetermined number of frames of the first RAT) in advance. The second RAT may also be scheduled for the same predetermined period of time in advance. Thus, a number of frames of the second RAT may be determined based on the predetermined number of frames of the first RAT (or based on the predetermined period). In particular, the number of frames of the second RAT may be calculated by dividing the predetermined period by the frame time of each of the frames of the second RAT. Accordingly, appropriate frame boundaries for the frames of the second RAT may be set.

Next at block B330, the scheduling module 140 may determine the blanking pattern of the second RAT for the number of frames of the second RAT corresponding to the predetermined number of the frames of the first RAT. As the scheduling module 140 is provided information regarding the activity pattern of the first RAT, the scheduling module 140 may determine the activities and inactivity of the first RAT during the predetermined period. The scheduling module 140 may blank out symbols for the second RAT when the first RAT utilizes the transmission hardware 150 for activities. Accordingly, at least a portion of a frame of the second RAT may be blanked out due to the activities of the first RAT. The blanking pattern of the second RAT is, thus, generated.

Next at block B340, the scheduling module 140 may determine the likelihood of successful transmission for each of the frames of the second RAT based on the blanking pattern of the second RAT. In particular, the scheduling module may determine the number of symbols blanked for each of the frames of the second RAT. As described, at least a portion (e.g., at least one symbol) of one of the frames of the second RAT may be blanked out due to activities of the first RAT. Given that each of the frames of the second RAT may include a known number of symbols, the likelihood of successful transmission may be determined by monitoring the number of symbols blanked out of the known number of symbols for that frame. The more symbols blanked (e.g., not transmitted), the more likely the content (e.g., data block) contained in that frame of the second RAT would not be successfully received (e.g., by the base station 120).

In further embodiments, the frame delay for each scheduled frame of the second RAT may be an additional factor in determining the usefulness of using a particular frame (such as, but not limited to, a likelihood of successful transmission). The longer the frame delay for a particular frame of the second RAT, the less favorable (or likely) the transmission of that particular frame of the second RAT is useful (e.g., successfully transmitted and/or received).

In one non-limiting example, likelihood of successful transmission may be presented as an index cost, which is a result of a cost function. For each of the frames of the second RAT (as identified by a unique frame index value), the index cost may be determined by the scheduling module 140. Such process may be described by the generalized index cost function ψ_{g}:

ψ_{g}(i)=Bᵢ+i,iεH (1)

“H” may be defined as the complete set of frame index values. Each of the frame index values may be associated with one of the frames of the second RAT for which transmission may be scheduled. “Bᵢ” may stand for the number of symbols blanked for the i-th frame of the second RAT. In addition, “i” may stand for the frame delay for the i-th frame of the second RAT. For example, the frames of the second RAT may be associated with frame index values 0-i, where the frame of the second RAT associated with the frame index value of 0 is to be transmitted immediately (i.e., the frame of the second RAT having the frame index value of 0 is the current frame of the second RAT). The frame of the second RAT associated with the frame index value i is to be transmitted after frames 0 to i−1 are transmitted. Accordingly, higher index cost (as determined from the cost function ψ_{g}) for an i-th frame of the second RAT indicates lower likelihood of successful transmission.

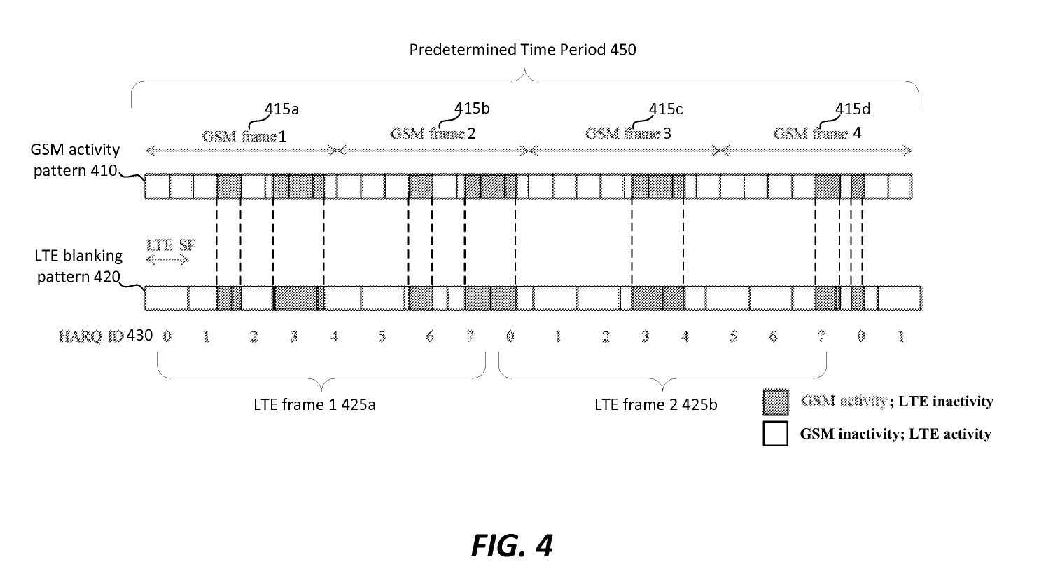

FIG. 4 is a block diagram illustrating an example of activity patterns associated with a first RAT and corresponding blanking patterns associated with a second RAT. In particular, FIG. 4 corresponds to the process 300 (FIG. 3) for determining a likelihood of successful transmission for one of the frames of the second RAT. For illustrative purposes, the first RAT may be GSM, and the second RAT may be LTE. The frames and subframes of GSM and LTE may be discussed in the context of uplink traffic. It should be appreciated by one of ordinary skills in the art that the process (e.g., the process 300) may also be applicable for RATs other than GSM and LTE, and for downlink traffic as well as for uplink traffic.

Now referring to FIGS. 1-4, an example of a GSM (e.g., the first RAT) activity pattern 410 is shown. With respect to the GSM activity pattern 410, the shaded areas may represent GSM activity, and the unshaded areas may represent GSM inactivity. Typically, GSM activities may be scheduled in advance for approximately 4 GSM frames (e.g., GSM frame 1 415a, GSM frame 2 415b, GSM frame 3 415c, and GSM frame 4 415d). The predetermined time period 450 associated with the 4 GSM frames may be approximately 20 ms. The predetermined time period 450 may be at least a portion of the time allotted for the GSM to be granted the transmission hardware 150. Accordingly, the GSM activity pattern 410 may be determined and relayed to the scheduling module 140.

The data traffic of LTE (e.g., the second RAT) may also be available in advance (e.g., for approximately the predetermined time period 450). LTE may also utilize the transmission hardware 150 for activities when GSM is assigned to the transmission hardware 150 as long as LTE does not interfere with the GSM's use. A corresponding number of LTE subframes and/or subframes may be determined based on the predetermined time period 450. In case of heavy traffic, eNodeB is expected to send UL grants for every subframe. Given that each LTE subframe is approximately 10 ms, 2 LTE subframes (e.g., LTE frame 1 425a and LTE frame 2 425b) may be available in advance. Each LTE subframe (for uplink) may include 8 subframes. In some embodiments, approximately 18 subframes may correspond to the 4 GSM frames.

The LTE may be associated with HARQ processes. Each subframe within a frame may be assigned a unique identifier (e.g., HARQ ID 430) as a frame index value. For example, the HARQ ID for a first subframe of the LTE frame 1 425a (as well as the first subframe of the LTE frame 2 425b) is 0, the HARQ ID for a second subframe of the LTE frame 1 425a (as well as the first subframe of the LTE frame 2 425b) is 1, . . . , and the HARQ ID for a last (e.g., eighth) subframe of the LTE frame 1 425a (as well as the first subframe of the LTE frame 2 425b) is 7.

Given that HARQ processes involve cyclic error correcting code, data blocks that failed to be transmitted via a subframe identified by one HARQ ID for the LTE frame 1 425a may be retransmitted via a subframe identified by the same HARQ ID for the LTE frame 2 425b. For example, a data block that has been unsuccessfully transmitted at a HARQ ID=0 at the LTE frame 1 425a may be retransmitted at HARQ ID=0 at the LTE frame 2 425b. In some embodiments described, a same HARQ ID may be associated with corresponding subframes from both the LTE frame 1 425a and the LTE frame 2 425b.

Next, the LTE blanking pattern 420 may be determined based on the GSM activity pattern 410. In short, when GSM is engaged in activities (e.g., transmission or reception), the corresponding area of the LTE blanking pattern 420 may be designated for inactivity. For example, the shaded areas for the LTE blanking pattern 420 may mirror the shaded areas for the GSM activity pattern 410. Where the shaded areas on GSM activity pattern 410 represents GSM activities, the shaded areas on the LTE blanking pattern 420 represents potential LTE inactivity. Similarly, where the unshaded areas on GSM activity pattern 410 represents GSM inactivity, the unshaded areas on the LTE blanking pattern 420 represents potential LTE activities.

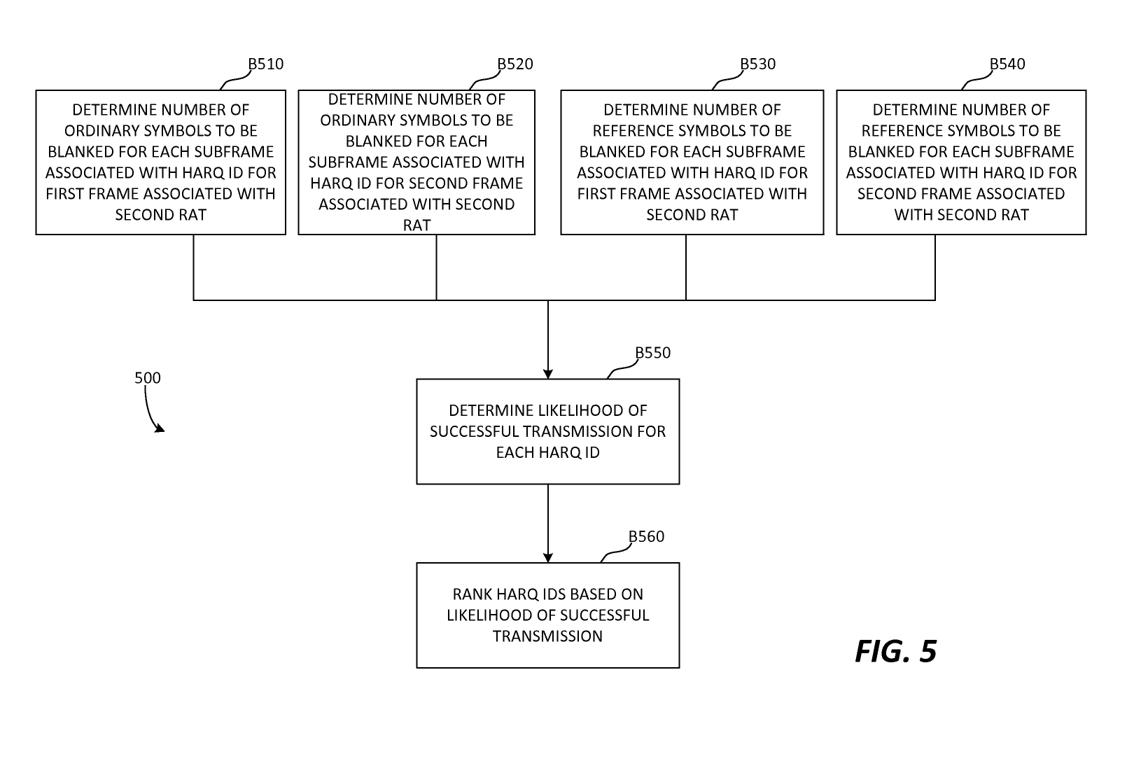

FIG. 5 is a process flowchart diagram illustrating an example of a likelihood determination process 500 for determining a likelihood of successful transmission for a frame index value according to various embodiments. More specifically, the likelihood determination process 500 may illustrate a non-limiting example of determining the likelihood of successful transmission for each HARQ ID (e.g., frame index) in the GSM, LTE, and HARQ context as set forth in FIG. 4. Now referring to FIGS. 1-5, the likelihood determination process 500 may be implemented on the UE 120. The likelihood determination process 500 may be particular implementations of the block B210 and the process 300.

At block B510, the scheduling module 140 may determine a number of ordinary symbols to be blanked for each subframe associated with a HARQ ID at a first frame associated with the second RAT (e.g., the LTE frame 1 425a). As described, each HARQ ID may be a frame index value identifying a particular subframe of the LTE frame 1 425a, which may include a plurality of subframes. Ordinary symbols (e.g., data symbols) may be content-holding data including substantive data information. Ordinary symbols may occupy particular areas within a subframe (e.g., at an end portion of symbols).

In some embodiments, there may be 12 ordinary symbols for extended cyclic prefix (ECP) and 14 ordinary symbols for normal cyclic prefix (NCP). In one example, the scheduling module 140 at block B510 may determine the number of ordinary symbols to be blanked for subframe [HARQ ID=0] for the LTE frame 1 425a. Given that no GSM activities (as denoted by shaded areas) are present for the subframe [HARQ ID=0] in LTE frame 1 425a, no symbols are blanked, much less ordinary symbols.

At block B520, the scheduling module 140 may determine a number of ordinary symbols to be blanked for each subframe associated with each HARQ ID at a second frame associated with the second RAT (e.g., the LTE frame 2 425b). As described, the LTE in the current example uses HARQ processes, which may be cyclic in nature. Corrupt and unsuccessful transmissions at a subframe in the LTE frame 1 425a may be retransmitted in the LTE frame 2 425b. Thus, a same HARQ ID may refer to two subframes, one in the LTE frame 1 425a and one in the LTE frame 2 425b. Accordingly, a same data block may be associated with a particular HARQ ID, such that the data block may be provided to the subframes of both the LTE frame 1 425a and the LTE frame 2 425b associated with the same HARQ ID. For example, a data block may be provided to both the subframe [HARQ ID=0] for the LTE frame 1 425a and the subframe [HARQ ID=0] for the LTE frame 2 425b. Thus, the likelihood of successful transmission relates to blanking with respect to both subframes associated with the same HARQ ID.

In one example, the scheduling module 140 at block B520 may determine the number of ordinary symbols to be blanked for subframe [HARQ ID=0] for the LTE frame 2 425b. As shown, approximately 4 ordinary symbols may be blanked due to GSM activities associated with GSM frame 2 415.

At block B530, the scheduling module 140 may determine a number of reference symbols to be blanked for each subframe associated with a HARQ ID at the first frame associated with the second RAT (e.g., the LTE frame 1 425a). Reference symbols may include structural-data (e.g., meta-data) used to decode (e.g., the pilot signals) or otherwise interpreted the substantive data included in the ordinary symbols. Example of the reference symbols include, but not limited to, the demodulation reference signals (DMRS), which may be 2 symbols per subframe. Reference symbols may occupy particular areas within a subframe, e.g., symbols 3 and 10 for NCP for physical uplink shared channel (PUSCH).

In one example, the scheduling module 140 at block B530 may determine the number of reference symbols to be blanked for subframe [HARQ ID=0] for the LTE frame 1 425a. Given that no GSM activities (as denoted by shaded areas) are present for the subframe [HARQ ID=0] of LTE frame 1 425a, no symbols are blanked, no reference symbols are blanked.

At block B540, the scheduling module 140 may determine a number of reference symbols to be blanked for each subframe associated with a HARQ ID at the second frame of the second RAT (e.g., the LTE frame 2 425b). In one example, the scheduling module 140 at block B540 may determine the number of reference symbols to be blanked for subframe [HARQ ID=0] for the LTE frame 2 425b. In one example, approximately 2 reference symbols may be blanked due to GSM activities associated with GSM frame 2 415.

The blocks B510, B520, B530, and B540 may be executed sequentially in any order. In other embodiments, two or more of the blocks B510, B520, B530, and B540 may be executed simultaneously. In some embodiments, the likelihood of successful transmission may not be determined for subframes having HARQ IDs associated with retransmission from previous frames.

Next at block B550, the scheduling module 140 may determine the likelihood of successful transmission for each HARQ ID (i.e., for each subframe associated with HARQ ID). In some embodiments, the likelihood of successful transmission for a HARQ ID may be calculated based on the number of ordinary symbols blanked for the subframe of the LTE frame 1 425a, number of ordinary symbols blanked for the subframe of the LTE frame 2 425b, number of reference symbols blanked for the subframe of the LTE frame 1 425a, number of reference symbols blanked for the subframe of the LTE frame 2 425b, a combination thereof, or the like. In further embodiments, frame delay may also be used to determine the favorability of choosing a particular HARQ ID for transmission. HARQ IDs with long delays may not be preferred for transmission.

In a non-limiting example, the likelihood of successful transmission may be presented as an index cost, which is a result of an index cost function. The index cost may be determined from the index cost function ψ(i) (e.g., equation (2)) for each HARQ ID by the scheduling module 140. The index cost function ψ(i) may be an evolved version of the generalized index cost function ψ_{g}(i) (e.g., equation (1)) to include implementation of the HARQ processes as well as weighting factors α₁, α₂, β₁, and β₂.

Index Cost Function ψ(i)=α₁Nᵢ⁽¹⁾+α₂Nᵢ⁽²⁾+β₁Mᵢ⁽¹⁾+β₂Mᵢ⁽²⁾+i,iεH (2)

“H” may be defined as the complete set of HARQ IDs 430 (e.g., 0-7) or the set of HARQ IDs that do not carry retransmission from previous subframes. Nᵢ⁽¹⁾ may represent the number of ordinary symbols to be blanked in the i-th HARQ ID for the LTE frame 1 425a. Nᵢ⁽²⁾ may represent the number of ordinary symbols to be blanked in the i-th HARQ ID for the LTE frame 2 425b. Mᵢ⁽¹⁾ may represent the number of reference symbols (e.g., DMRS symbols) to be blanked in the i-th HARQ ID for the LTE frame 1 425a. Mᵢ⁽²⁾ may represent the number of reference symbols (e.g., DMRS symbols) to be blanked in the i-th HARQ ID for the LTE frame 2 425b.

In addition, “i” may stand for the frame delay for the i-th frame of the second RAT. In some embodiments, it is assumed that that the HARQ ID at the current subframe is 0. In some embodiments, the frames of the second RAT may be associated with HARQ ID values 0-i, where the frame of the second RAT associated with the HARQ ID value of 0 is to be transmitted immediately. The frame of the second RAT associated with the HARQ ID value i is to be transmitted after frames 0 to i−1 are transmitted. Accordingly, higher index cost (e.g., HARQ IQ cost as determined from the cost function ψ_{g} indicates lower likelihood of successful transmission.

In some embodiments, weighting factors α₁, α₂, β₁, and β₂ may be added as shown in the index cost function ψ(i) (e.g., equation (2)) to modify the index cost function ψ(i) to emphasize the importance of passing the cyclic redundancy check (CRC) in the first and/or the second LTE subframe. For example, α₁ represents the importance of successful transmission of the ordinary symbols upon the first LTE subframe (e.g., the LTE frame 1 425a). α₂ represents the importance of successful transmission of the ordinary symbols upon the second LTE subframe (e.g., the LTE frame 2 425b). β₁ represents the importance of successful transmission of the reference symbols upon the first LTE subframe (e.g., the LTE frame 1 425a). β₂ represents the reference of successful transmission of the ordinary symbols upon the second LTE subframe (e.g., the LTE frame 2 425b). Accordingly, each of the weighting factors α₁, α₂, β₁, and β₂ may modify their respective terms Nᵢ⁽¹⁾, Nᵢ⁽²⁾, Mᵢ⁽¹⁾.

For example, large β₁, and/or β₂ (e.g., 10, 100, 1000, or ∞) may be assigned to denote the importance of reference symbols, without all of which the base station 110 would not be able decode the ordinary symbols. As compared to β₁, and/or β₂, α₁ and α₂ may be given lesser value (e.g., 1, 2, 5, or 10), given a considerable amount of ordinary symbols may be blanked before an actual failure.

In some embodiments, the weighting factors may be static. In other embodiments, the weighting factors may be dynamically set. As the number of symbols blanked (e.g., Nᵢ⁽¹⁾, Nᵢ⁽²⁾, Mᵢ⁽¹⁾, Mᵢ⁽²⁾, or the like) increases, the corresponding weighting factors may also increase. These weighting factors may vary with modulation coding scheme (MCS) as described herein. In summary, a HARQ ID associated with a large index cost as defined by the ψ(i) may indicate less likelihood of successful transmission given that the subframe associated with the HARQ ID may include a large number of ordinary and/or reference symbols to be blanked, and/or the HARQ ID may be associated with longer delay.

In some embodiments, the number of symbols blanked (e.g., Nᵢ⁽¹⁾, Nᵢ⁽²⁾, Mᵢ⁽¹⁾, Mᵢ⁽²⁾, and the like) may be determined for one subframe, then the next. An index cost may be determined according to the index cost function ψ(i) for every HARQ ID i.

At block B560, the scheduling module 140 may rank the HARQ IDs based on the likelihood of successful transmission. As described, in some embodiments, the likelihood of successful transmission may be based on the index cost calculated from the index cost function ψ(i), where the index cost decreases as the likelihood of successful transmission increases. Each HARQ ID may be associated with an index cost. The HARQ IDs may be ranked in any suitable order according to their associated index cost. In particular embodiments, the HARQ IDs may be ranked in an ascending order, where the HARQ ID associated with the lowest index cost may be the first ordered element in an ordered set (e.g., ordered vector V).

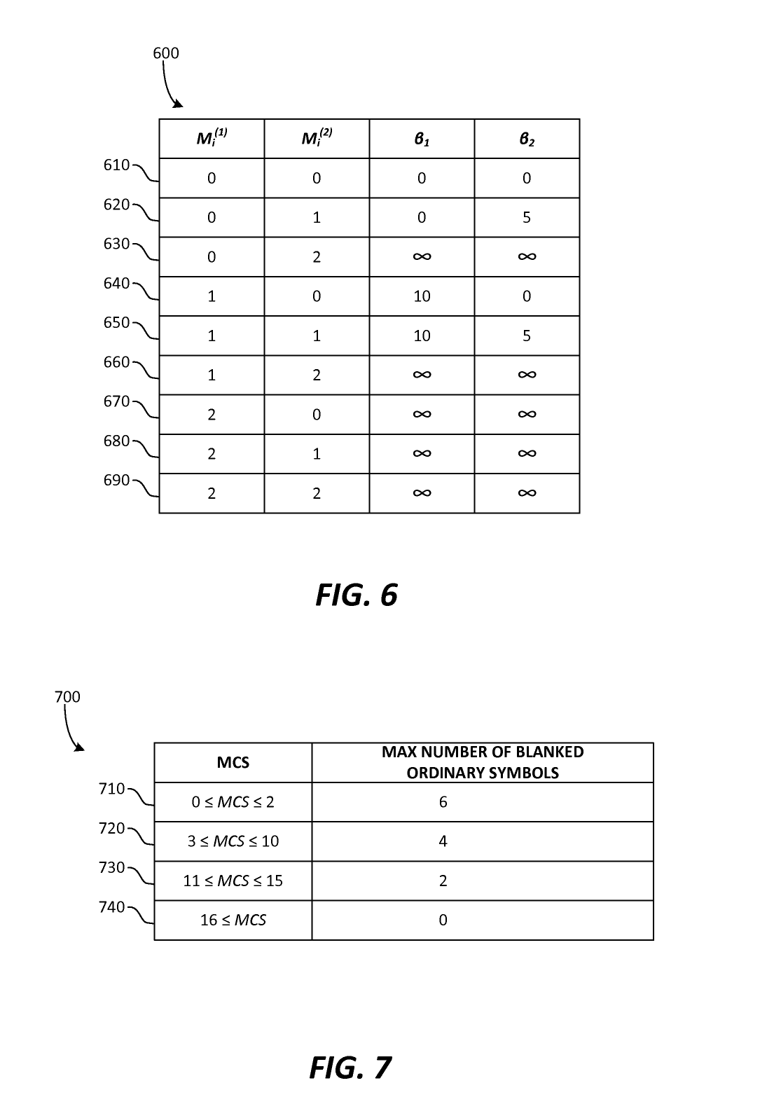

FIG. 6 is an example of a weighting factor mapping table 600 illustrating an example of a relationship between the at least one weight factor and a corresponding number of symbols blanked. Referring to FIGS. 1-6, the weighting factor mapping table 600 may illustrate the relationship between the weighting factors β₁/β₂ and their associated number of reference symbol blanked Mᵢ⁽¹⁾, Mᵢ⁽²⁾. As described above, there may be 2 reference symbols in every subframe for each of the LTE frame 1 425a and the LTE frame 2 425b.

In some embodiments, there is no likelihood of success when both reference symbols associated with one LTE subframe are blanked. With no reference symbols (e.g., the DMRS symbol), the base station 110 may not be able to decode the ordinary data blocks. Thus, when either Mᵢ⁽¹⁾, Mᵢ⁽²⁾ is 2, both the weighting factors β₁ and β₂ may be set to ∞, as shown in a third entry 630, a sixth entry 660, a seventh entry 670, an eighth entry 680, and a ninth entry 690. In some embodiments, the weight factors β₁ and β₂ may be set to 0 as both of the Mᵢ⁽¹⁾ and Mᵢ⁽²⁾ are 0s, as shown in the first entry 610.

According to various embodiments, when the number of reference symbols blanked for the i-th HARQ ID on LTE frame 1 425a (e.g., Mᵢ⁽¹⁾) is 1 while the other the number of reference symbols blanked for the same HARQ ID on the LTE frame 2 425b (e.g., Mᵢ⁽²⁾) is 0 or 1, the β₁ is assigned a first number less than ∞ (e.g., 10). Such is illustrated in a fourth entry 640 and a fifth entry 650. When the number of reference symbols blanked for the LTE frame 2 425b (e.g., Mᵢ⁽²⁾) is 1 while the other the number of reference symbols blanked for the LTE frame 1 425a (e.g., Mᵢ⁽¹⁾) is 0 or 1, the β₂ is assigned a second number less than ∞ (e.g., 5). Such is illustrated in a second entry 620 and the fifth entry 650. In these embodiments, the first number may be greater than the second number (e.g., by two times, three times, ten times, and/or the like).

The weighting factors β₁ and β₂ (as well as α₁ and α₂) may be altered (e.g., at the scheduling module 140) automatically or manually by the user via an interface of the UE 120.

FIG. 7 is an example of relationship table 700 illustrating the relationship between the modulation and coding scheme (MCS) and the number of ordinary symbols blanked. With reference to FIGS. 1-7, in some embodiments, an approximate maximum number of ordinary symbols blanked corresponding to a range of MSC may be illustrated by the relationship table 700. In more specific terms, the approximate maximum number of ordinary symbols blanked may represent, for each MCS range, the maximum of ordinary symbols blanked for a successful physical uplink shared channel (PUSCH) process while still passing CRC. A MCS requirement for the number of ordinary symbols blanked may be created according to relationship table 700. The PUSCH carries uplink content data (e.g., as in the ordinary symbols) and reference data (e.g., in the reference symbols).

In generally, at lower MCS regions, more ordinary symbols may be blanked before an unsuccessful transmission occurs. On the other hand, at high MCS regions, blanking of a very few ordinary symbols may not be tolerated. In good channel conditions, for MCS range A 710 (e.g., 0≦MCS≦2), approximately up to 6 ordinary symbols may be blanked before unsuccessful transmission occurs. For MCS range B 720 (e.g., 3≦MCS≦10), approximately up to 4 ordinary symbols may be blanked before unsuccessful transmission occurs. For MCS range C 730 (e.g., 11≦MCS≦15), approximately up to 2 ordinary symbols may be blanked before unsuccessful transmission occurs. For MCS range D 740 (e.g., 16≦MCS), any ordinary symbols blanked would likely to cause unsuccessful transmission.

In some embodiments, α₁ is weighed heavier than α₂ given that the first LTE subframe (e.g., the first transmission, such as the LTE frame 1 425a) may often be associated with more systematic bits as compared to the second LTE subframe (e.g., the second transmission, such as the LTE frame 2 425b).

In particular embodiments, the scheduling module 140 may determine whether the MCS requirements as set forth in the relationship table 700 are met. When the MCS requirements are violated (e.g., the maximum number of blanked ordinary symbols is exceeded for a given MCS range), both of α₁ and α₂ may be set to be ∞ (i.e., the transmission on that HARQ ID is likely to fail).

When the scheduling module 140 determines that the MCS requirements are met, α₁ may be set to be a first number and α₂ may be set to be a second number. In some embodiments, the first number (e.g., 5, 10, 20, 50, or the like) may be greater than the second number (e.g., 1, 5, 10, 25, and the like, respectively corresponding to the examples of the first number). In other embodiments, the α₁ and α₂ may be equal. In other words, all ordinary symbols may be weighted equally. For example, both of the α₁ and α₂ may be 1, 2, 4, 5, and/or the like. In any case, the α₁ and α₂ may be adjusted at the scheduling module 140 to fine-tune the α₁ and α₂ (e.g., via a user interface associated with the UE 120 or updates).

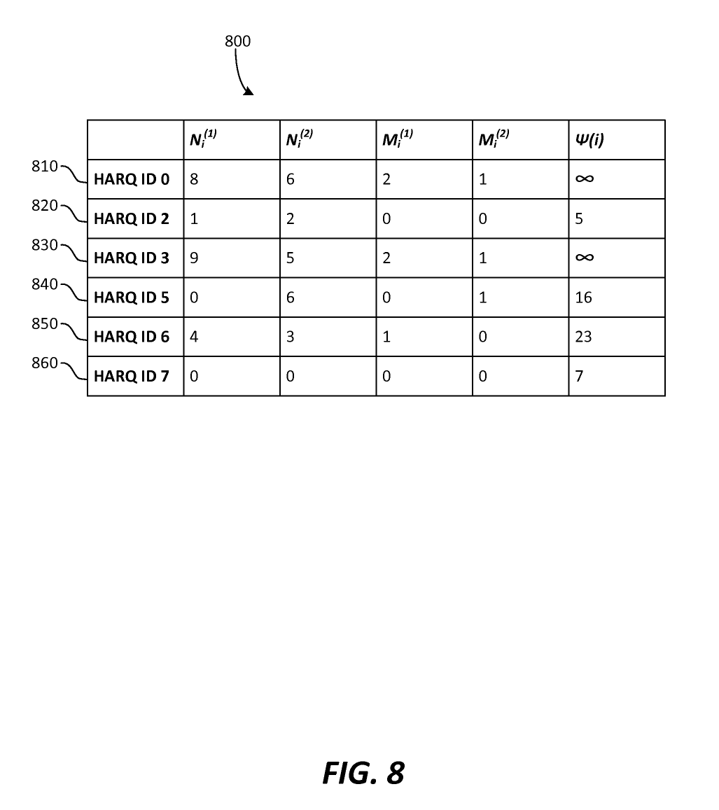

FIG. 8 is an HARQ ID cost table 800 illustrating examples of the index cost associated with each HARQ ID. Referring to FIGS. 1-8, the HARQ IDs 340 of subframes associated with retransmission frames (e.g., subframe [HARQ ID=1] and subframe [HARQ ID=4]) may be omitted for index cost determination. This is because data blocks may not be assigned for those particular HARQ IDs. In some embodiments, the HARQ ID cost table 800 shows the numbers of symbols blanked (e.g., Nᵢ⁽¹⁾, Nᵢ⁽²⁾, Mᵢ⁽¹⁾, and Mᵢ⁽²⁾) and their associated HARQ ID cost determined according to the likelihood determination process 500.

In particular, the HARQ ID cost table 800 utilizes the HARQ ID cost function ψ(i) in determining the HARQ ID cost. While it should be appreciated that the α₁ and α₂ determination scheme set forth with respect to the relationship table 700 may implemented herein, α₁ and α₂ may be configured to be 1 for simplicity. The determination scheme for β₁ and β₂ as set forth in the weighting factor mapping table 600 may be applicable for the HARQ ID cost table 800.

For HARQ ID A 810 (e.g., subframe [HARQ ID=0] and HARQ ID C 830 (e.g., subframe [HARQ ID=3]), the HARQ ID cost is determined to be ∞ given that the number of reference symbols blanked for either frame (e.g., Mᵢ⁽¹⁾ for the LTE frame 1 425a for both the HARQ index A 810 and the HARQ index C 830) exceeds 2. When either Mᵢ⁽¹⁾ or Mᵢ⁽²⁾ is equal to 2, the β₁ and β₂ may both be set to be ∞. Thus, the HARQ ID cost is driven to ∞.

For HARQ ID B 820 (e.g., subframe [HARQ ID=2], both Mᵢ⁽¹⁾ and Mᵢ⁽²⁾ may be 0. Nᵢ⁽¹⁾, Nᵢ⁽²⁾, and the HARQ ID (e.g., i=2) are added together to obtain the index cost of 5. For HARQ ID D 840 (e.g., subframe [HARQ ID=5], Mᵢ⁽¹⁾ is 0 and Mᵢ⁽²⁾ 1, based on which β₂ is set to be 5. Nᵢ⁽¹⁾ and Nᵢ⁽²⁾ are added to β₂Mᵢ⁽²⁾ (e.g., 5) and the HARQ ID (e.g., i=5) to obtain the index cost of 16.

For HARQ ID E 850 (e.g., subframe [HARQ ID=6], Mᵢ⁽¹⁾ is 1 and Mᵢ⁽²⁾ is 0, based on which is set to be 10. Nᵢ⁽¹⁾ and Nᵢ⁽²⁾ are added to β₁Mᵢ⁽¹⁾ (e.g., 10) and the HARQ ID (e.g., i=6) to obtain the index cost of 23. For HARQ ID F 860 (e.g., subframe [HARQ ID=7], no symbols are blanked. Thus, the index cost is simply the HARQ ID, which is 7.

The scheduling module 140 may rank the HARQ IDs (e.g., the HARQ IDs) in ascending or descending order based on the associated index cost in a manner such as, but not limited to, described with respect to block B560. In particular embodiments, an ordered vector V may be generated to rank the HARQ IDs in ascending order of the associated index cost. For example, for the index cost table 800 as illustrated, V=[2, 7, 5, 6, 0, 3]. V(0) (e.g., the HARQ ID B 820 [HARQ ID=2]) is the most favorable subframe for transmission given the lowest index cost (e.g., 5). On the other hand, V[5] (e.g., the HARQ ID A 810 [HARQ ID=0]) and V[6] (e.g., the HARQ ID C 830 [HARQ ID=3]) are associated with large index cost (e.g., ∞) and are likely to fail. Accordingly, the scheduling module 140 may bypass these frames by not assigning corresponding data blocks to be transmitted therein.

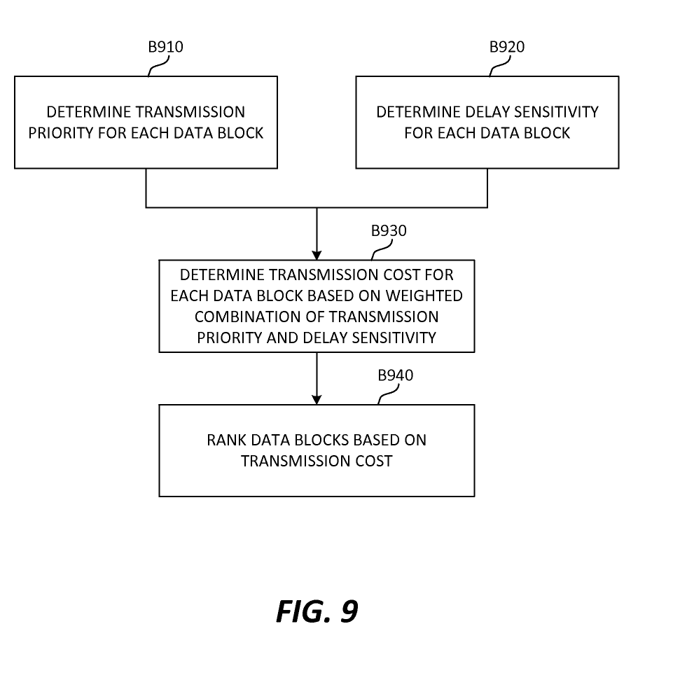

FIG. 9 is a process flowchart diagram illustrating a transmission cost determination process 900 for determining a transmission cost associated with a data block according to various embodiments. Referring to FIGS. 1-9, the transmission cost determination process 900 may illustrate an example implantation of the block B220 of the traffic scheduling process 200.

At block B910, the scheduling module 140 may determine a transmission priority for each data block. In some embodiments, a plurality of data blocks may be identified to be transmitted via the transmission hardware 150. These data blocks may be placed in a preliminary queue to standby for frame or subframe (e.g., for subframes associated with particularly index values, such as the HARQ IDs) assignment.

In some embodiments, the transmission priority for each data block may be determined based on a classification of the content associated with each data block. In some embodiments, the classification may be based on specific data types associated with a media access control (MAC) layer. For example, data classifications such as such that signaling radio bearer (SRB) data, transmission control protocol acknowledgment (TCP ACK) data, radio link control acknowledgement (RLC ACK) data blocks are associated with a high priority level. The rest of user data is usually of lower priority.

At block B920, the scheduling module 140 may determine delay sensitivity for each data block. Content of data blocks may be associated with a variety of data types. Each data time may correspond to a different level of delay sensitivity (or inversely, the delay tolerance). A plurality of delay tolerance levels may be defined, where each delay tolerance level may be associated with a set of data types for data blocks. For example, the transmission control protocol acknowledgment (TCP ACK) data, radio link control acknowledgement (RLC ACK) data, ping packets, user data with packet data convergence protocol (PDCP) discard timer running out and VOLTE data blocks are associated with high delay sensitivity. The browsing data blocks and other user data are associated with low delay sensitivity.

The blocks B910 and B920 may be executed sequentially in any order. In other embodiments, the blocks B910 and B920 may be executed simultaneously.

Next at block B930, the scheduling module 140 may determine transmission cost for each data block based on the weighted combination of transmission priority and delay sensitivity. In particular embodiments, the transmission cost may be determined based on a transmission cost function, e.g., Φ(j):

Φ(j)=Dⱼ−Pⱼ (3)

In some embodiments, Dⱼ may represent the delay tolerance of the data block having an index j. In some embodiments, Dⱼ may be a number associated with the delay tolerance of the data block. The value of Dⱼ increases as the delay tolerance increase (or decreases as the delay sensitive increases) of the data block. Pⱼ may represent the priority of the data block having the index j. In some embodiments, Pⱼ may be a number associated with the priority level of the data block. The value of Pⱼ increases with the priority of the data block (e.g., the larger the value of Pⱼ, the more the data block is to be prioritized for transmission).

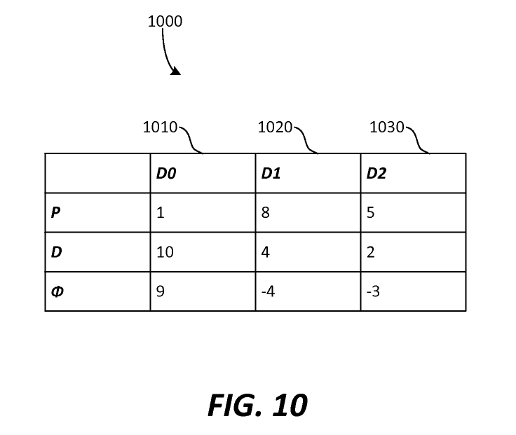

FIG. 10 is a transmission cost table 1000 according to various embodiments. Referring to FIG. 1-10, the transmission cost table includes three entries, each of which may be associated with a data block. For example, a data block index D0 1010 may be associated with a first data block. A data block index D1 1020 may be associated with a second data block. A data block index D2 1030 may be associated with a third data block. For each of the data block index, the transmission cost is determined according to the transmission cost function Φ(j) (3).

In some embodiments, the data block index D0 1010 may be associated with the priority level P₀ of 1 (e.g., relatively low priority) and the delay tolerance D₀ of 10 (e.g., relatively low delay sensitivity). The transmission cost associated with the data block index D0 1010 may be 9. In some embodiments, the data block index D1 1020 may be associated with the priority level P₁ of 8 (e.g., relatively high priority) and the delay tolerance D₁ of 4 (e.g., relatively intermediate delay sensitivity). The transmission cost associated with the data block index D1 1020 may be −4. In some embodiments, the data block index D2 1030 may be associated with the priority level P₂ of 5 (e.g., relatively intermediate priority) and the delay tolerance D₂ of 2 (e.g., relatively low delay sensitivity). The transmission cost associated with the data block index D1 1020 may be −3.

In other embodiments, the transmission cost may be determined based on one of the priority and delay sensitivity.

Referring generally to FIGS. 1-10 and specifically to FIG. 9, following block B930 at block B940, the scheduling module 140 may rank the data blocks based on the transmission cost determined in block B930.

In particular embodiments, an ordered vector O may be generated to rank the data block indexes (e.g., the data block index D0 1010, the data block index D1 1020, and the data block index D2 1030) in ascending order of the associated transmission cost. For example, for the transmission cost table 1000 as illustrated, O=[D1, D2, D0]. The data block index D1 1020 is associated with the lowest transmission cost and is therefore of higher priority/higher delay sensitivity. On the other hand, the data block index D0 1010 is associated with the highest transmission cost and is therefore of a lower priority/lower delay sensitivity.

Now referring generally to FIGS. 1-10 and specifically to FIG. 2, at block B230, the scheduling module 140 may assign each data block to one of the frames of the second RAT based on the likelihood of successful transmission for each of the frames of the second RAT and the transmission cost for each data block. In some embodiments, the likelihood of successful transmission may be represented by the index cost as calculated from the generalized index cost function ψ_{g}(i) (e.g., equation (1)) and/or the index cost function ψ(i) (e.g., equation (2)). The transmission cost may be calculated from the transmission cost function Φ(j) (e.g., equation (3)).

Accordingly, the ordered vector V (for ranking the HARQ IDs, in ascending order, based on the index cost) and the ordered vector O (for ranking the data block indexes, in ascending order, based on the transmission cost) may be obtained. For each element of the ordered vector O, an element of the ordered vector V is assigned based on the ordering of the elements in both the ordered vector O and the ordered vector V. In particular embodiments, the n-th element of the ordered vector O is assigned to correspond with the n-th element of the ordered vector V. For example, O(0) (e.g., data block index D1 1020) may be assigned to V(0) (e.g., the HARQ ID B [HARQ ID=2]); O(1) (e.g., data block index D2 1030) may be assigned to V(1) (e.g., the HARQ ID F [HARQ ID=7]); and O(2) (e.g., data block index D0 1010) may be assigned to V(2) (e.g., the HARQ ID D [HARQ ID=5]). Accordingly, the frames having more likelihood of successful transmission may be assigned to the data blocks having the lowest transmission cost (higher priority/higher delay sensitivity).

In some embodiments, two or more disparate data blocks may be associated with the same delay sensitivity and/or priority. In this case, the ranking of the data blocks may not be material. However, one of ordinary skill in the art would appreciate that, the data blocks may still be assigned to frames (subframes, slots, or the like) that are likely to be successful in transmission and therefore favored. Accordingly, at the very least, unsuccessful frames may be bypassed.

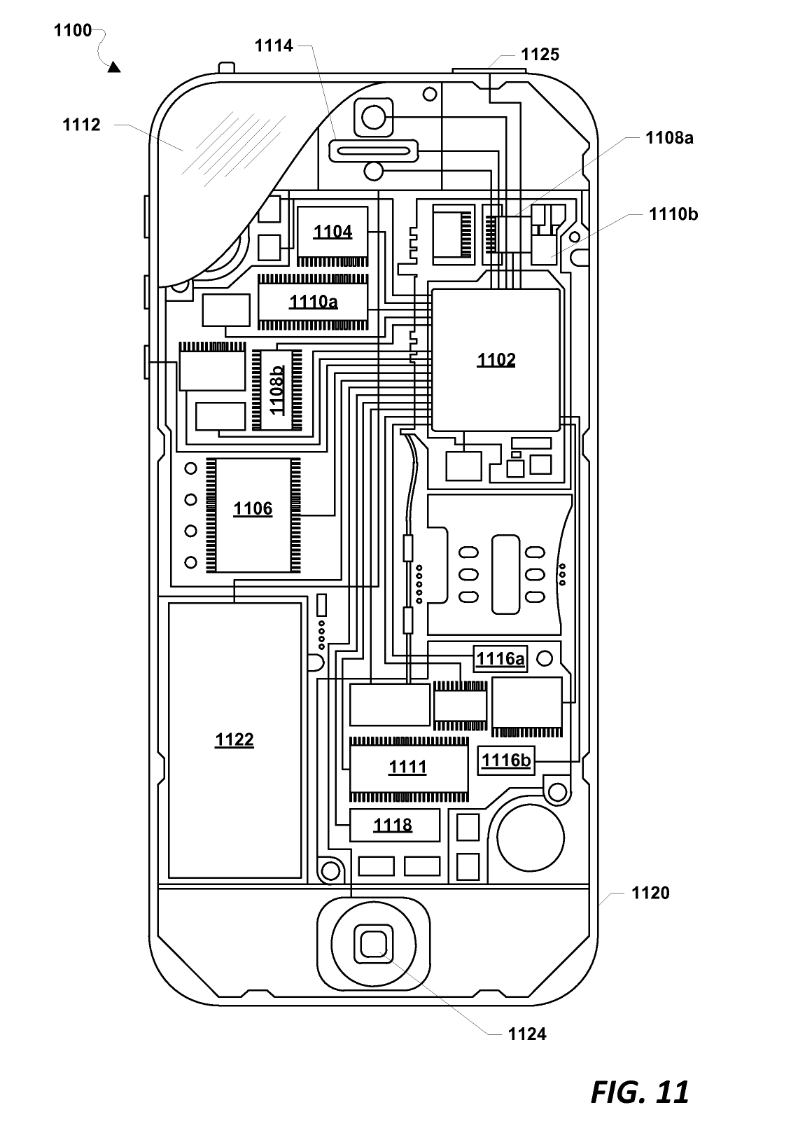

The various embodiments may be implemented in any of a variety of UE 120, an example of which is illustrated in FIG. 11, as a UE 1100. As such, the UE 1100 may implement the process and/or the apparatus of FIGS. 1-10, as described herein.

With reference to FIGS. 1-11, the UE 1100 may include a processor 1102 coupled to a touchscreen controller 1104 and an internal memory 1106. The processor 1102 may be one or more multi-core integrated circuits designated for general or specific processing tasks. The memory 1106 may be volatile or non-volatile memory, and may also be secure and/or encrypted memory, or unsecure and/or unencrypted memory, or any combination thereof. The touchscreen controller 1104 and the processor 1102 may also be coupled to a touchscreen panel 1112, such as a resistive-sensing touchscreen, capacitive-sensing touchscreen, infrared sensing touchscreen, etc. Additionally, the display of the UE 1100 need not have touch screen capability.

The UE 1100 may have one or more cellular network transceivers 1108a, 1108b coupled to the processor 1102 and to two or more antennae 1110 and configured for sending and receiving cellular communications. The transceivers 1108 and antennae 1110a, 1110b may be used with the above-mentioned circuitry to implement the various embodiment methods. The cellular network transceivers 1108a, 1108b may be the transmission hardware 150. The antennae 1110a, 1110b may be the antenna 160. The UE 1100 may include two or more SIM cards 1116a, 1116b, corresponding to SIM A 104a and SIM B 104b, coupled to the transceivers 1108a, 1108b and/or the processor 1102. The UE 1100 may include a cellular network wireless modem chip 1111 (e.g., the baseband processor 130) that enables communication via a cellular network and is coupled to the processor.

The UE 1100 may include a peripheral device connection interface 1118 coupled to the processor 1102. The peripheral device connection interface 1118 may be singularly configured to accept one type of connection, or multiply configured to accept various types of physical and communication connections, common or proprietary, such as USB, FireWire, Thunderbolt, or PCIe. The peripheral device connection interface 1118 may also be coupled to a similarly configured peripheral device connection port (not shown).

The UE 1100 may also include speakers 1114 for providing audio outputs. The UE 1100 may also include a housing 1120, constructed of a plastic, metal, or a combination of materials, for containing all or some of the components discussed herein. The UE 1100 may include a power source 1122 coupled to the processor 1102, such as a disposable or rechargeable battery. The rechargeable battery may also be coupled to a peripheral device connection port (not shown) to receive a charging current from a source external to the UE 1100. The UE 1100 may also include a physical button 1124 for receiving user inputs. The UE 1100 may also include a power button 1126 for turning the UE 1100 on and off.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A process for scheduling transmission for a first radio access technology (RAT) and a second RAT, the process comprising:
determining likelihood of successful transmission for each of a plurality of frames associated with the second RAT based on an activity pattern associated with the first RAT;
determining transmission cost associated with each of a plurality of data blocks transmittable via the second RAT; and
assigning a first data block of the plurality of data blocks to a frame of the plurality of frames based, at least in part, on the likelihood of successful transmission associated with the frame and the transmission cost associated with the first data block.

2. The process of claim 1, wherein:
the first RAT is Global System for Mobile Communication (GSM); and
the second RAT is Long Term Evolution (LTE).

3. The process of claim 1, wherein:
the first RAT is associated with voice transmission; and
the second RAT is associated with data transmission.

4. The process of claim 1, wherein the first RAT is a different RAT from the second RAT.

5. The process of claim 1, further comprising:
receiving the activity pattern associated with the first RAT; and
determining the blanking pattern associated with the second RAT based on the activity pattern received, wherein at least one symbol of one of the plurality of frames is blanked due to the activity pattern.

6. The process of claim 1, wherein:
the determining of the likelihood of successful transmission comprises determining, for each of the plurality of frames, a number of symbols blanked due to the activity pattern associated with the first RAT; and
the likelihood of successful transmission decreases as the number of symbols blanked increases.

7. The process of claim 1, wherein the determining of the likelihood of successful transmission is determined for each of the plurality of frames based on at least one of the following attributes associated with each of the plurality of frames: data symbols blanked, reference symbols blanked, and frame delay.

8. The process of claim 6, wherein the determining of the likelihood of successful transmission is determined based on a weighted combination of the data symbols blanked, the reference symbols blanked, and the frame delay.

9. The process of claim 1, wherein the determining of the transmission cost associated with each of the plurality of data blocks is determined based on at least one of: priority associated with each of the plurality of data blocks and delay sensitivity associated with each of the plurality of data blocks.

10. The process of claim 8, wherein the priority associated with each of the plurality of data blocks is determined based on classification associated with each of the plurality of data blocks.

11. The process of claim 9, wherein the classification corresponds to a media access control (MAC) layer, such that signaling radio bearer (SRB) data, transmission control protocol acknowledgment (TCP ACK) data, radio link control acknowledgement (RLC ACK) data blocks are associated with a high priority level, and that user application data blocks are associated with a low priority.

12. The process of claim 8, wherein the delay sensitivity associated with each of the plurality of data blocks is determined based on classification associated with each of the plurality of data blocks.

13. The process of claim 8, wherein the determining of the transmission cost is a weighted combination of the priority and the delay sensitivity.

14. The process of claim 8, wherein the transmission cost decreases as the priority increases.

15. The process of claim 8, wherein the transmission cost decreases as the delay sensitivity increases.

16. The process of claim 1, further comprising assigning a second data block of the plurality of data blocks to another frame of the plurality of frames, wherein the first data block is associated with a lower transmission cost than the second data block, and the frame is associated with a higher likelihood of successful transmission than the another frame.

17. A system for scheduling transmission for a first radio access technology (RAT) and a second RAT, the system comprising:
a scheduling module, the scheduling module configured to:
determine likelihood of successful transmission for each of a plurality of frames associated with the second RAT based on an activity pattern associated with the first RAT;
determine transmission cost associated with each of a plurality of data blocks transmittable via the second RAT; and
assign a first data block of the plurality of data blocks to a frame of the plurality of frames based, at least in part, on the likelihood of successful transmission associated with the frame and the transmission cost associated with the first data block.

18. The system of claim 17, wherein:
the first RAT is Global System for Mobile Communication (GSM); and
the second RAT is Long Term Evolution (LTE).

19. The system of claim 17, wherein:
the first RAT is associated with voice transmission; and
the second RAT is associated with data transmission.

20. The system of claim 17, wherein the first RAT is a different RAT from the second RAT.

21. The system of claim 17, the scheduling module is further configured to:
receive the activity pattern associated with the first RAT; and
determine the blanking pattern associated with the second RAT based on the activity pattern received, wherein at least one symbol of one of the plurality of frames is blanked due to the activity pattern.

22. The system of claim 17, wherein:
the scheduling module determines the likelihood of successful transmission by determining, for each of the plurality of frames, a number of symbols blanked due to the activity pattern; and
the likelihood of successful transmission decreases as the number of symbols blanked increases.

23. The system of claim 17, wherein the likelihood of successful transmission is determined by the scheduling module for each of the plurality of frames based on at least one of the following attributes associated with each of the plurality of frames: data symbols blanked, reference symbols blanked, and frame delay.

24. The system of claim 17, wherein the transmission cost associated with each of the plurality of data blocks is determined by the scheduling module based on at least one of: priority associated with each of the plurality of data blocks and delay sensitivity associated with each of the plurality of data blocks.

25. The system of claim 24, wherein the transmission cost is a weighted combination of the priority and the delay sensitivity.

26. The system of claim 24, wherein the transmission cost decreases as the priority increases.

27. The system of claim 24, wherein the transmission cost decreases as the delay sensitivity increases.

28. The system of claim 17, the scheduling module is further configured to assign a second data block of the plurality of data blocks to another frame of the plurality of frames, wherein the first data block is associated with a lower transmission cost than the second data block, and the frame is associated with a higher likelihood of successful transmission than the another frame.

29. A non-transitory computer readable-medium containing instructions such that, when executed, causes a processor to:
determine likelihood of successful transmission for each of a plurality of frames associated with the second RAT based on an activity pattern associated with the first RAT;
determine transmission cost associated with each of a plurality of data blocks transmittable via the second RAT; and
assign a first data block of the plurality of data blocks to a frame of the plurality of frames based, at least in part, on the likelihood of successful transmission associated with the frame and the transmission cost associated with the first data block.

30. A system for scheduling transmission for a first radio access technology (RAT) and a second RAT, the system comprising:
means for determining likelihood of successful transmission for each of a plurality of frames associated with the second RAT based on an activity pattern associated with the first RAT;
means for determining transmission cost associated with each of a plurality of data blocks transmittable via the second RAT; and
means for assigning a first data block of the plurality of data blocks to a frame of the plurality of frames based, at least in part, on the likelihood of successful transmission associated with the frame and the transmission cost associated with the first data block.
